(19) United States
(12) Patent Application Publication
(10) Pub. No.: US 2025/0123912 A1
(43) Pub. Date: Apr. 17, 2025

(54) CUSTOMIZATION OF APPLICATION PROGRAMMING INTERFACES

(71) Applicant: Dell Products L.P., Round Rock, TX (US)

(72) Inventors: RAMYA RAMAKRISHNAN, Bangalore (IN); ABHIRUP SEAL, Bangalore (IN); SUNIL SHRIRAM KHANNADE, Bangalore (IN)

(21) Appl. No.: 18/488,548

(22) Filed: Oct. 17, 2023

(51) Int. Cl. G06F 9/54

(52) U.S. Cl. CPC G06F 9/547

(57) ABSTRACT

Methods and systems for managing distribution of data in a distributed system are disclosed. The data may be distributed by application programming interfaces that provide access to data included in database or other types of data structures. The application programming interfaces may allow custom resources to be defined and used. The use of custom resources may reduce the overhead for obtaining data by allowing desired data to automatically be provided in response to invocation of functionality of the application programming interfaces.

### FIELD

Embodiments disclosed herein relate generally to workload management. More particularly, embodiments disclosed herein relate to systems and methods to manage workload distribution across shared infrastructure.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2B show data flow diagrams in accordance with an embodiment.

FIG. 3 shows a flow diagram illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing access to data. To provide various computer implemented services, information from a distributed system may need to be distributed to locations where the data is processed and/or otherwise used.

To facilitate data distribution, application programming interfaces (APIs) may be utilized. The APIs may be Representational State Transfer (REST) APIs that facilitate stateless distribution of information through invocation of functions of the REST APIs. To read data, for example, a function may be invoked and a uniform resource identifier (URI) may be provided. The invoked function and URI may enable the REST API to identify relevant data and provide the relevant data in response to the request.

However, the URI may only be associated with corresponding data. Consequently, to obtain other data, another invocation and a different URI may need to be provided to the REST API.

To reduce the number of invocations necessary to obtain desired data, a custom resource may be created by providing the REST API with information defining the behavior of the custom resource. For example, invocation of the custom resource may return various portions of data that would otherwise require multiple invocations for the data to be obtained.

Once the custom resource is in place, only a URI of the custom resource may need to be provided and a single invocation be made for all of the desired data to be returned. In this manner, data associated with multiple existing resources may be retrieved via a single call to the REST API.

Thus, embodiments disclosed herein may address, among others, the technical problem of limited computing resources. By reducing overhead through request consolidation via implementation of a custom resource, the computing resource cost for obtaining data may be reduced. Accordingly, the limited computing resources of the distributed system may be preferentially directed to use in providing desired computer implemented services rather than being consumed in mere data gathering activity.

In an embodiment, a method for managing access to data is provided. The method may include obtaining, by a service device, a new resource creation request for a Representational State Transfer (REST) application programming interface (API) hosted by the service device; identifying, by the service device and based on the new resource creation request, at least one data source uniform resource identifier of the REST API; establishing, by the service device, a new custom resource for the REST API, the new custom resource having a new data source uniform resource identifier, and the new custom resource being usable to obtain a portion of the data associated with the at least one data source uniform resource identifier; obtaining, by the service device and from a client device, an invocation of the REST API, the new data source uniform resource identifier be provided as part of the invocation; and in response to the invocation, providing, by the service device and to the client device, the portion of the data.

The at least one data source uniform resource identifier may include a first data source uniform resource identifier and a second data source uniform resource identifier.

The REST API may associate the first data source uniform resource identifier with a first sub-portion of the portion of the data and the second data source uniform resource identifier with a second sub-portion of the portion of the data.

Prior to obtaining the new resource creation request, the REST API may not include any data source uniform resource identifiers associated with both the first sub-portion of the portion (e.g., a property of a resource) of the data and the second sub-portion (e.g., a second property of a similar or different resource) of the portion of the data.

The new custom resource may associate the first sub-portion of the portion of the data and the second sub-portion of the portion of the data with the new data source uniform resource identifier.

The method may also include obtaining, by the service device and from a second client device, a second invocation of the REST API, the first data source uniform resource identifier be provided as part of the second invocation; in response to the second invocation, providing, by the service device and to the second client device, the first sub-portion of the portion of the data; obtaining, by the service device and from a third client device, a third invocation of the REST API, the second data source uniform resource identifier be provided as part of the third invocation; and in response to the third invocation, providing, by the service device and to the third client device, the first sub-portion of the portion of the data.

The REST API may include a customizable resource.

The new resource creation request may include a criteria usable to discriminate the at least one data source uniform resource identifier from other data source uniform resource identifiers of the REST API.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

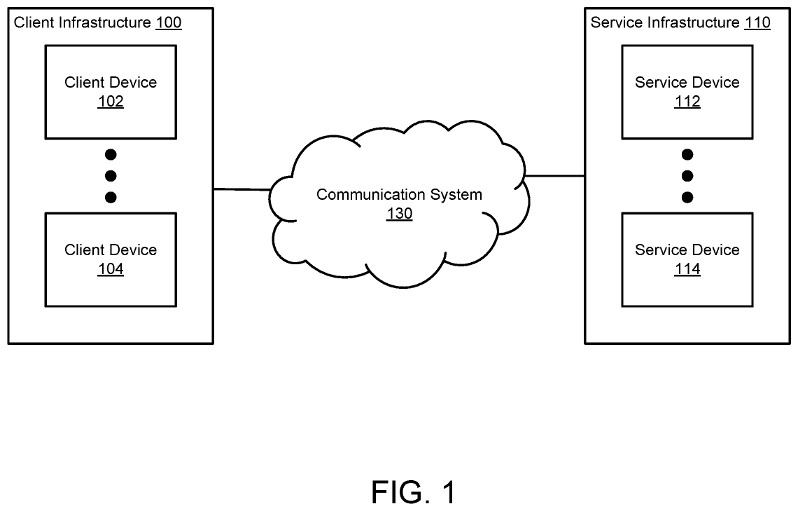

Turning to FIG. 1, a block diagram illustrating a system in accordance with an embodiment is shown. The system shown in FIG. 1 may provide computer-implemented services. The computer implemented services may include any type and quantity of computer implemented services. For example, the computer implemented services may include data storage services, instant messaging services, database services, and/or any other type of service that may be implemented with a computing device.

To provide the computer implemented services, workloads may be performed by various components of the system. To perform the workloads, various information may need to be obtained. Similarly, when workloads are performed various types of new information may become available for use.

The information used in the workloads may be available from various devices of the system. To facilitate access to the information, any of the devices of the system may host instances of application programming interfaces (APIs). The APIs may be used by other devices and/or applications (e.g., hosted by other or the same device) to obtain data that may include information usable in workloads.

To facilitate ease of use, any of the APIs may be implemented as Representational State Transfer (RST) APIs. The REST APIs may associate uniform resource identifiers (URIs) with various resources (e.g., data sources). The resources may have various properties corresponding to different types of data available via the REST APIs. The data may be stored in a database which the REST APIs may receive when requests directed to the URIs are received.

For example, to utilize a REST API, a data consumer may generate a request that includes a URI. Once sent to a data source hosting the REST API, the request may be interpreted by identifying the resources specified by the URI, and obtaining corresponding data from a database. The data may be returned to service the request. If no properties are specified, then properties of the resource may be returned (similarly, if a property is not associated with data, then sub-properties of the property may be returned to enable a data consumer to identify properties relevant for use).

However, the above approach may incur significant overhead due to the discrete nature of requests for information from REST APIs. For example, to obtain information corresponding to properties of multiple resources, multiple discrete requests may need to be sent and/or multiple properties for a resources may need to be specified. Thus, the size of the requests and/or number of requests may grow as the type and quantity of desired data scales depriving data providers and data consumers of uses of computing resources for other purposes.

In general, embodiments disclosed herein may provide methods, systems, and/or devices for facilitating access to data. To facilitate access to data, APIs used to provide access to the data may enable creation of custom resources based on existing resources supported by the APIs.

To create a custom resources, information regarding a desired resource may be obtained. The information may indicate (i) the resources and properties of resources that are desired to be obtained efficiently, (ii) new URIs for the custom resource, and/or other types of information usable to establish a new resources. Once the information is obtained, a new resource may be created or an existing resource may be updated to act as the new resource.

Once created, the new resource may be utilized by data consumers. To do so, when information from the custom resource is desired, a REST API may be invoked by sending a request to the REST API that includes the new URI. Once obtained, the REST API may utilize the new URI to identify the custom resources. The custom resource may be used to identify where in a database the data corresponding to previously defined resources/property are located. Once identified, copies of the data may be retrieved and returned to the data consumer.

In this manner, a data consumer may, after establishment of a custom resource, may only need to invoke use of the REST API once to obtain all of the information previously defined to be provided via the custom resource. Consequently, multiple separate invocations (e.g., sending of requests) may not need to be used to obtain all of the information. Thus, a system in accordance with an embodiment may more efficiently marshal limited computing resources for providing desired computer implemented services by reducing computational overhead for obtaining information used in the computer implemented services. Accordingly, a device may provide larger numbers of computer implemented services when compared to devices of systems that do not include REST APIs that provide for custom resource creation.

To provide for the above noted functionality, the system of FIG. 1 may include client infrastructure 100, service infrastructure 110 and communication system 130. Each of these components is discussed below.

Client infrastructure 100 may provide desired computer implemented services. To do so, client infrastructure 100 may include any number of client devices (e.g., 102-104). The client devices may provide the computer implemented services cooperatively and/or individually.

To provide the computer implemented services, the client device may utilize information maintained by service infrastructure 110. To do so, the client devices may (i) invoke REST APIs hosted by service infrastructure 110 to obtain data, and (ii) use the obtained data to provide the computer implemented services. To obtain information efficiently, the client devices may monitor their use of the REST APIs to identify instances of repetitive calls made to the REST APIs. When repetitive calls are identified, client infrastructure 100 may invoke custom resource creation functionality of service infrastructure 110 to create custom resources. After creation, the client devices may utilize the custom resources to obtain relevant data thereby reducing overhead (e.g., by consolidating multiple calls into a single call).

Service infrastructure 110 may provide access to information used in the computer implemented services. To do so, service infrastructure 110 may host REST APIs, databases, and/or other data structures usable to store and provide access to stored information. Additionally, service infrastructure 110 include custom resource creation functionality through which custom resources may be established and used by other devices to access data maintained by service infrastructure 110.

To provide its functionality, service infrastructure 110 may include any number of service devices (e.g., 112-114). The services devices may provide access to information cooperatively or individually.

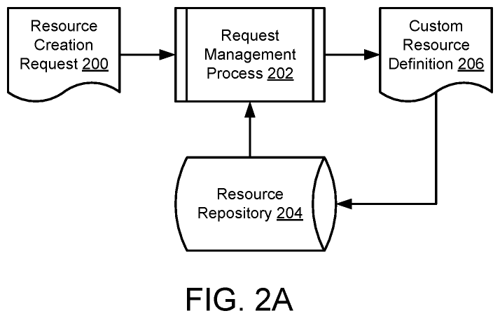

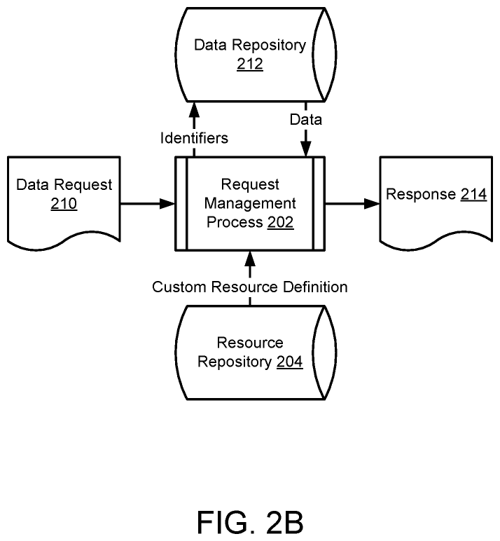

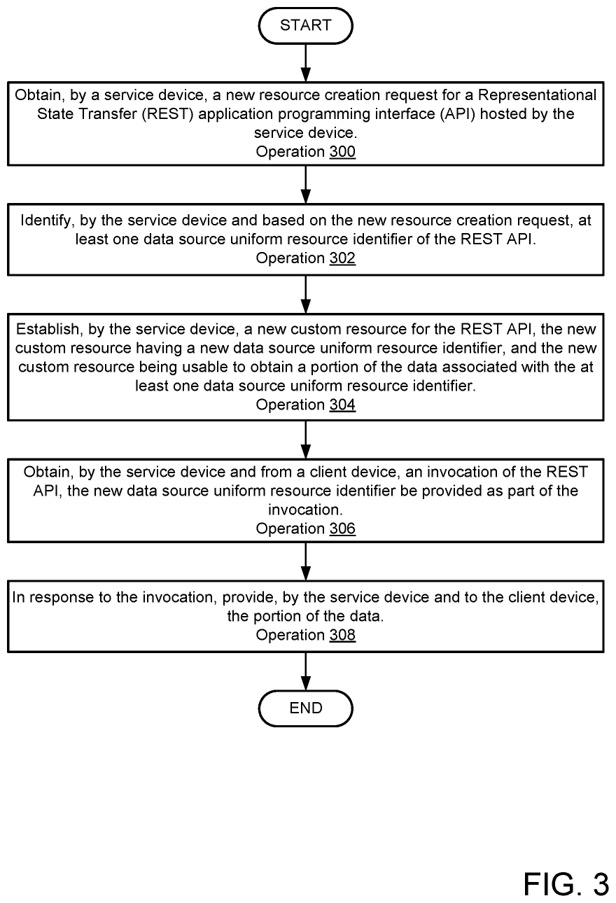

When providing their functionality, any of client infrastructure 100 and service infrastructure 110 (and/or a portion thereof) may perform the flows and methods illustrated in FIGS. 2A-3.

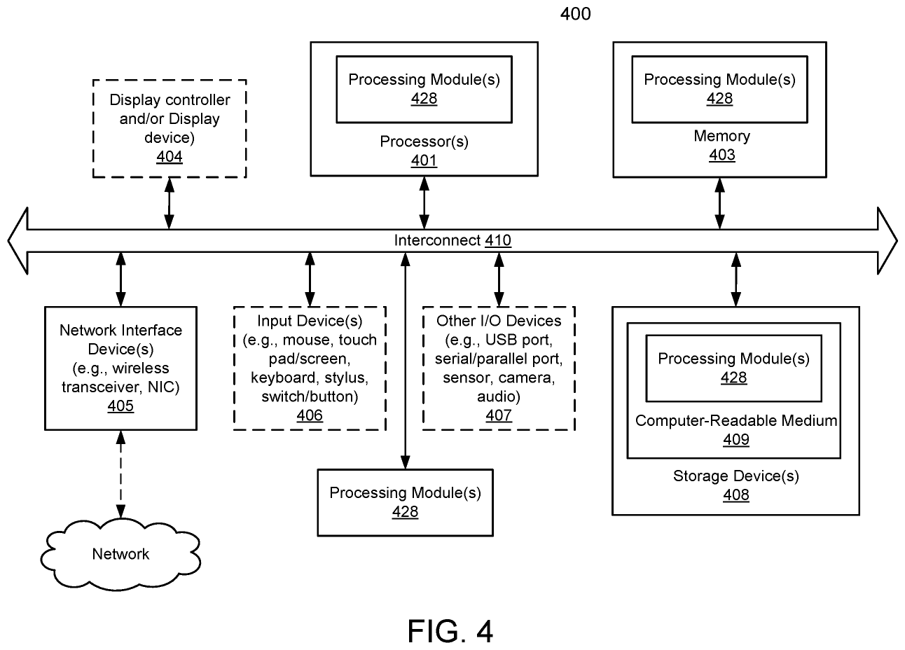

Client infrastructure 100 and service infrastructure 110 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 130. In an embodiment, communication system 130 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

To further clarify embodiments disclosed herein, data flow diagrams in accordance with an embodiment are shown in FIGS. 2A-2B. In these diagrams, flows of data and processing of data are illustrated using different sets of shapes. A first set of shapes (e.g., 200, 206, etc.) is used to represent data structures, a second set of shapes (e.g., 202, etc.) is used to represent processes performed using and/or that generate data, and a third set of shapes (e.g., 204, 212, etc.) is used to represent large scale data structures such as databases.

Turning to FIG. 2A, a first data flow diagram in accordance with an embodiment is shown. The first data flow diagram may illustrate data used in and data processing performed in creation of custom resources.

Overtime, a user (e.g., a person, an automated process, etc.) of a REST API may identify that they are regularly submitting similar sets of requests to the API to obtain data from the API. This approach may be inefficient, time consuming, and/or may be otherwise undesirable

To address repetitive submission of similar requests, a custom resource may be added to the API. To do so, resource creation request 200 may be submitted to the API. Resource creation request 200 may specify the data to be added to the custom resource. The data may be specified by, for example, including URIs corresponding to any number of existing resources, and/or properties of the resources. The URIs may indicate the specific data to be provided when future requests directed toward the custom resource are received.

Resource creation request 200 may also include information regarding properties for the custom resource, URIs for the custom resource and/or properties of the custom resource, relationships between the properties, etc.

When resource creation requests is obtained by the API, resource creation request 200 may ingested by request management process 202. Requests management process 202 may service requests sent to the API.

During request management process 202, resource creation request 200 may parse resource creation request 200 thereby identifying that it is a resource creation requests rather than a request for data or other type of requests.

Once parsed, request management process 202 may use the URIs to identify corresponding data for the custom resource using resource repository 204. Resource repository 204 may include definitions for existing resources. Thus, the URIs may be usable to lookup existing resources and/or properties of the resources identified by the URIs included in resource creation request 200.

Once the data is identified, custom resource definition 206 may be generated. Custom resource definition 206 may be a definition that links the new URIs from resource creation request 200 to the data identified using the URIs of the existing resources. Thus, when a new request for data is received and that includes instances of the new URIs, custom resource definition 206 may be used to identify the corresponding data to service the request. In this manner, any quantity of data, that had previously required multiple API calls to retrieve, may be retrieved using a single API call thereby reducing overhead for processing multiple requests.

Once obtained, custom resource definition 206 may be stored in resource repository 204 for future use. Refer to FIG. 2B for additional details regarding use of custom resource definition 206 to service requests.

Thus, using the method illustrated in FIG. 2A, embodiments disclosed herein may reduce overhead for distributing data in accordance with a REST API.

While described with respect to be provided by a user, it will be appreciated that resource creation requests 200 may be obtained via automated means. For example, the REST API may monitor API call activity of various entities. The API call activity may be monitored to identify patterns of API calls to retrieve various type of data. When a pattern is identified, a resource creation requests may be automatically generated and presented to an administrator or other person/system. Statistic information regarding the resource creation requests, projected overhead savings, and/or other information regarding a new custom resource based on the resource creation requests may also be prevented. The person/system may authorize or deny creation of a custom resource based on the information.

Additionally, while described with respect to creation of a resource, it will be appreciated that an existing resource may be customized based on resource creation request 200, rather than a new resource being created. For example, the REST API may include any number of customizable resources which may be customized based on various resource creation requests.

Turning to FIG. 2B, a second data flow diagram in accordance with an embodiment is shown. The second data flow diagram may illustrate data used in and data processing performed in servicing of requests.

To service a request, request management process 202 may be performed. During requests management process 202, various data requests may be obtained, parsed, and processed.

For example, data request 210 may be obtained by receiving it from an application, another device, and/or another type of entity. Data request 210 may invoke functionality of a REST API. Data requests 210 may include any number of URIs which may associated with custom resources.

If associated with a custom resource, the corresponding custom resource definition from resource repository 204 may be used to identify corresponding portions of data stored in data repository 212. For example, the URIs from data requests 210 may be used to perform lookups in resource definitions to identify the data requests by data request 210. The corresponding portions of data may be retrieved from data repository 212.

Data repository 212 may store any type and quantity of data. For example, data repository 212 may be implemented using a database, and may serve as a repository of data accessible via the REST API. The data may be organized in accordance with a data model with which the REST API is aligned.

The obtained data may be used to generate response 214. Response 214 may include the data requested by data request 210. Once obtained, response 214 may be provided to a requestor (e.g., that made the data request) or to another designated entity.

Thus, using the data flow shown in FIG. 2B, a curated, custom collection of data may be retrieved from a REST API using a single request. The collection of data may include portions of data associated various resources that may otherwise require separate requests to obtain.

As discussed above, the components of FIG. 1 may perform various methods to manage operation of data processing systems. FIG. 3 illustrates a method that may be performed by the components of the system of FIG. 1. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method for distributing data in accordance with an embodiment is shown. The method may be performed by any of client infrastructure 100, service infrastructure 110, and/or other components of the system shown in FIG. 1.

At operation 300, a new resource creation request for a REST API hosted by a service device is obtained by the service device. The new resource creation request may be obtained by receiving it via a message from a client device, by reading it from storage, and/or via other methods.

The new resource creation request may indicate that a new resource is to be created, and the new resource is to be usable to obtain one or more pieces of data. For example, the new resource creation requests may include any number of URIs (and/or other identification information) that are usable to identify data associated with existing resources.

For example, prior to operation 300, a client device may utilize the REST API to obtain information regarding the status of ports of any number of network devices such as routers, switches, etc. The client device may be doing so to decide how to efficient distribute data to any number of devices operably connected to the network devices. The service device may host a database that stored information regarding the statuses of the ports of the devices. The REST API may provide access to the information in the database. For example, the REST API may associate various URIs with corresponding network devices (e.g., resources) with the ports and corresponding information being properties of the resources (e.g., each also being associated with a URI). Thus, to obtain information regarding the status of ports of the network devices, the client device may generate and send separate requests with URIs corresponding to the resources, the properties, etc. When received by the REST API, each request may be separately processed and serviced by identifying and returning relevant data from the database (e.g., using a data model that associated the URIs with data in the database).

However, this approach may incur significant overhead on the part of the service device and client device through generation and processing of separate requests. To address this issue, the client device may generate and send the custom resource requests by identifying the frequently sent requests and using the resources/URIs from the requests to create the new resource creation request. The service device may also add a URI that will be used in the future to discriminate the new resource from other resources.

At operation 302, at least one data source uniform resource identifier of the REST API is identified by the service device and based on the new resource creation request. The at least one data source URI may be identified by reading the data source URIs from the new resource creation request. The at least one data source URIs may be those that, in the previous example, the client device added to the new resource creation request, and may be associated with existing resources for which the client device has been interested in obtaining information about. In other words, the at least one data source URIs may be associated with existing resources that have been subjects of previous generated requests for data submitted to the REST API.

At operation 304, a new custom resource for the REST API is established. The new custom resource for the REST API may be established by generating a new resource definition (e.g., that links URIs to portions of data in the database) or customizing an existing resource (e.g., by updating an existing resource definition, which may be written in JSON or another form). The new resource definition may be generated by adding information from the new resource creation request to it and associating it with various portions of data in a database. Consequently, when a URI associated with the new custom resource is included in a data request, the new resource definition may be usable to identify, obtain, and distribute relevant information back to a requestor.

The new custom resource may have a new data source uniform resource identifier. For example, the new resource creation request may specify the new URI. The new URI may be used to invoke the new resource.

The new custom resource may be usable to obtain a portion of the data associated with the at least one data source URI. In other words, the new custom resource may be usable to obtain any number of portions of data from a database that were previously only accessible via multiple data requests.

Once created, the new resource definition may be added to a repository and may be used to service future data requests obtained from client devices, applications, and/or other entities. Doing so may update the REST API so that data requests that include the new URI may be serviced.

At operation 306, an invocation of the REST API is obtained. The invocation may be obtained by receiving a data request from another entities. The request may be a data request and may include the URI for the new custom resource. Thus, the data source URI may be provided to the service device as part of the invocation.

At operation 308, in response to the invocation, the portion of the data is provided to the client device by the service device. The portion of the data may be provided by (i) parsing the data request to obtain the new data source URI, (ii) using a resource definition associated with the new data source URI to process the request to identify the portion of the data in a database, (iii) read the portion of the data from the database, (iv) add the portion of the data to a response, and (iv) send the response to the client device to provide the portion of the data to the client device.

The method may end following operation 308.

Following operation 308, the client device may provide computer implemented services using the portion of the data. For example, returning to the network device example, the provided data may indicate the port states of the network devices. The port states and network topology may be used to identify how to obtain data from other device, how to distribute data to other devices, etc. Once identified, various portions of data may be distributed via the network devices.

The aforementioned process may be repeated and/or performed continuously to maintain alignment between the process performed by the client device and the state of the network. For example, as closed ports open, the routing and/or other aspects of data collection and dissemination may be updated over time to align the process being performed with the network topology.

Thus, using the method shown in FIG. 3, embodiments disclosed herein may more efficiently marshal limited computing resources for providing desired computer implemented services by reducing overhead for distributing data via REST APIs (and/or other types of interfaces). It will be appreciated that while described with respect to REST APIs, other types of interfaces may benefit from embodiments disclosed herein.

Any of the components illustrated in FIGS. 1-2B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing access to data, the method comprising:
obtaining, by a service device, a new resource creation request for a Representational State Transfer (REST) application programming interface (API) hosted by the service device;
identifying, by the service device and based on the new resource creation request, at least one data source uniform resource identifier of the REST API;
establishing, by the service device, a new custom resource for the REST API, the new custom resource having a new data source uniform resource identifier, and the new custom resource being usable to obtain a portion of the data associated with the at least one data source uniform resource identifier;
obtaining, by the service device and from a client device, an invocation of the REST API, the new data source uniform resource identifier be provided as part of the invocation; and
in response to the invocation, providing, by the service device and to the client device, the portion of the data.

2. The method of claim 1, wherein the at least one data source uniform resource identifier comprises a first data source uniform resource identifier and a second data source uniform resource identifier.

3. The method of claim 2, wherein the REST API associates the first data source uniform resource identifier with a first sub-portion of the portion of the data and the second data source uniform resource identifier with a second sub-portion of the portion of the data.

4. The method of claim 3, wherein prior to obtaining the new resource creation request, the REST API did not include any data source uniform resource identifiers associated with both the first sub-portion of the portion of the data and the second sub-portion of the portion of the data.

5. The method of claim 4, wherein the new custom resource associates the first sub-portion of the portion of the data and the second sub-portion of the portion of the data with the new data source uniform resource identifier.

6. The method of claim 3, further comprising:
obtaining, by the service device and from a second client device, a second invocation of the REST API, the first data source uniform resource identifier be provided as part of the second invocation;
in response to the second invocation, providing, by the service device and to the second client device, the first sub-portion of the portion of the data;
obtaining, by the service device and from a third client device, a third invocation of the REST API, the second data source uniform resource identifier be provided as part of the third invocation; and
in response to the third invocation, providing, by the service device and to the third client device, the first sub-portion of the portion of the data.

7. The method of claim 1, wherein the REST API comprises a customizable resource.

8. The method of claim 7, wherein the new resource creation request comprises a criteria usable to discriminate the at least one data source uniform resource identifier from other data source uniform resource identifiers of the REST API.

9. A non-transitory machine-readable medium having instructions stored therein, which when executed by a processor, cause the processor to perform operations for managing access to data, the operations comprising:
obtaining, by a service device, a new resource creation request for a Representational State Transfer (REST) application programming interface (API) hosted by the service device;
identifying, by the service device and based on the new resource creation request, at least one data source uniform resource identifier of the REST API;
establishing, by the service device, a new custom resource for the REST API, the new custom resource having a new data source uniform resource identifier, and the new custom resource being usable to obtain a portion of the data associated with the at least one data source uniform resource identifier;
obtaining, by the service device and from a client device, an invocation of the REST API, the new data source uniform resource identifier be provided as part of the invocation; and
in response to the invocation, providing, by the service device and to the client device, the portion of the data.

10. The non-transitory machine-readable medium of claim 9, wherein the at least one data source uniform resource identifier comprises a first data source uniform resource identifier and a second data source uniform resource identifier.

11. The non-transitory machine-readable medium of claim 10, wherein the REST API associates the first data source uniform resource identifier with a first sub-portion of the portion of the data and the second data source uniform resource identifier with a second sub-portion of the portion of the data.

12. The non-transitory machine-readable medium of claim 11, wherein prior to obtaining the new resource creation request, the REST API did not include any data source uniform resource identifiers associated with both the first sub-portion of the portion of the data and the second sub-portion of the portion of the data.

13. The non-transitory machine-readable medium of claim 12, wherein the new custom resource associates the first sub-portion of the portion of the data and the second sub-portion of the portion of the data with the new data source uniform resource identifier.

14. The non-transitory machine-readable medium of claim 13, further comprising:
obtaining, by the service device and from a second client device, a second invocation of the REST API, the first data source uniform resource identifier be provided as part of the second invocation;
in response to the second invocation, providing, by the service device and to the second client device, the first sub-portion of the portion of the data;
obtaining, by the service device and from the second client device, a third invocation of the REST API, the second data source uniform resource identifier be provided as part of the third invocation; and
in response to the third invocation, providing, by the service device and to a third client device, the first sub-portion of the portion of the data.

15. The non-transitory machine-readable medium of claim 9, wherein the REST API comprises a customizable resource.

16. The non-transitory machine-readable medium of claim 15, wherein the new resource creation request comprises a criteria usable to discriminate the at least one data source uniform resource identifier from other data source uniform resource identifiers of the REST API.

17. A data processing system, comprising:
a processor; and
a memory coupled to the processor to store instructions, which when executed by the processor, cause the processor to perform operations for managing access to data, the operations comprising:
obtaining, by a service device, a new resource creation request for a Representational State Transfer (REST) application programming interface (API) hosted by the service device;
identifying, by the service device and based on the new resource creation request, at least one data source uniform resource identifier of the REST API;
establishing, by the service device, a new custom resource for the REST API, the new custom resource having a new data source uniform resource identifier, and the new custom resource being usable to obtain a portion of the data associated with the at least one data source uniform resource identifier;
obtaining, by the service device and from a client device, an invocation of the REST API, the new data source uniform resource identifier be provided as part of the invocation; and
in response to the invocation, providing, by the service device and to the client device, the portion of the data.

18. The data processing system of claim 17, wherein the at least one data source uniform resource identifier comprises a first data source uniform resource identifier and a second data source uniform resource identifier.

19. The data processing system of claim 18, wherein the REST API associates the first data source uniform resource identifier with a first sub-portion of the portion of the data and the second data source uniform resource identifier with a second sub-portion of the portion of the data.

20. The data processing system of claim 19, wherein prior to obtaining the new resource creation request, the REST API did not include any data source uniform resource identifiers associated with both the first sub-portion of the portion of the data and the second sub-portion of the portion of the data.
